(19) United States
(12) Patent Application Publication
(10) Pub. No.: US 2016/0233917 A1
(43) Pub. Date: Aug. 11, 2016

(54) DEVICE FOR FORMING WIRELESS HIGH-FREQUENCY SIGNAL PATH AND METHOD FOR CONTROLLING SAME

(71) Applicant: KMW Inc., Hwaseong (KR)

(72) Inventors: Young-Chan Moon, Hwaseong (KR); Sung-Hwan So, Hwaseong (KR); Myong-Sik Lee, Hwaseong (KR); Dong-Hun Lee, Hwaseong (KR); Yong-Hyo Jeon, Anyang (KR)

(21) Appl. No.: 15/131,054

(22) Filed: Apr. 18, 2016

Related U.S. Application Data
(63) Continuation of application No. PCT/KR2014/009724, filed on Oct. 16, 2014.

(30) Foreign Application Priority Data
Oct. 17, 2013 (KR) 10-2013-0124147

(51) Int. Cl. H04B 1/401; H01Q 3/24; H04L 29/08; H01Q 1/24

(52) U.S. Cl. CPC H04B 1/401; H01Q 1/246; H01Q 3/24; H04L 69/324

(57) ABSTRACT

The present invention relates to a device for forming a wireless high-frequency signal path, comprising: a plurality of output ends respectively connected so as to correspond to a plurality of antenna arrays; a plurality of input ends respectively connected so as to correspond to a plurality of amplifiers; a switching module for forming a path for variably connecting each of the plurality of input ends to one selected from the plurality of output ends according to a switching control signal; and a control unit for receiving an external command and outputting a switching control signal for controlling a switching operation of the switching module according to the external command.

### CROSS REFERENCE TO RELATED APPLICATIONS

This application is a continuation of International Application No. PCT/KR2014/009724 filed on Oct. 16, 2014, which claims priority to Korean Application No. 10-2013-0124147 filed on Oct. 17, 2013, which applications are incorporated herein by reference.

### TECHNICAL FIELD

The present invention relates to a technology that can be applied to a base station including a repeater in a wireless communication (e.g., PCS, Cellular, CDMA, GSM, LTE, etc.) system, and a wireless high-frequency signal path forming device provided to/from a base station antenna and a method for controlling the same.

### BACKGROUND ART

Typically, a base station of a wireless communication system may be divided into a base station main body for processing transmission/reception signals and a base station antenna having a plurality of radiating elements therein and transmitting/receiving a wireless signal. Typically, the base station main body is installed at a lower position on the ground, the base station antenna part is installed at higher position such as a rooftop or a tower, and a power supply cable is connected therebetween.

In recent years, thanks to the increase of easy installation of a tower because devices for processing wireless signals are small and light, a structure for installing, at an antenna front end, a remote wireless device such as a Tower Mounted Amplifier (TMA) or a Remote Radio Head (RRH), etc. responsible for the processing of the transmission/reception wireless signal has been widely applied, so as to compensate for cable losses at the time of signal transmission between the antenna and the base station main body. That is, the base station main body for processing the transmission/reception signals is divided into an RF signal processing part and a baseband signal processing part, and only the baseband signal processing part is provided in the base station main body, and the RF signal processing part is provided in a remote wireless device. In this case, the base station main body may be regarded as “baseband signal processing device”. At this time, typically, the transmission/reception signal is transferred between the base station main body (the base band signal processing device) and the remote wireless device by using an optical communication method in order to prevent transmission signal losses therebetween, and a coaxial cable and the like is connected therebewtween in order to supply an operating power to the remote wireless device.

On the other hand, a radiation structure of the base station antenna may have various shapes and structures, and currently, a wireless communication antenna generally uses a conventional dual polarized antenna structure by applying a polarization diversity scheme. The dual polarized antenna structure has a structure for generating two linear-polarized waves, also known as, X polarized waves in which a plurality of radiating elements are orthogonal to each other. At least one radiation module made up of such a plurality of radiating elements is arranged on a reflector, typically, multiple radiation modules are elongated arranged in a longitudinal direction so as to form one antenna array.

In recent years, the base station antenna may have a multiple antenna structure where multiple antenna arrays are installed on one reflector or installed on each of the reflectors. The multiple antenna structure includes a multi-band antenna structure where multiple antenna arrays based on multiple bands are provided on one reflector or each of the reflectors, (in combination with a multi-band structure) a Multi Input Multi Output (MIMO) structure for each band, or a beam-forming antenna structure, for example, where three or more antenna arrays are arranged in the same band.

In addition, the base station antenna may typically include an Antenna Line Device (ALD) such as a Remote Electrical Tilt (RET) device for adjusting a remotely controllable electronical down tilt angle, a Remote Azimuth Steering (RAS) device for remotely adjusting azimuth steering, and a Remote Azimuth Beamwidth (RAB) device for remotely adjusting a beam width of the azimuth. An example of an antenna including the devices is disclosed in Korean Patent Publication No. 10-2010-0122092 first filed by Amphenol Corporation (published on Nov. 19, 2010 and entitled “Multi-beam Antenna with Multi-device Control Unit”; inventors Gregory Girard and Frank Soulie).

For control of the RET device, the RAS device, and the RAB device, Antenna Interface Standards Group (AISG) v2.1.0 was recently devised, and a communication scheme through the 3rd Generation Partnership Project (3GPP) protocol was also developed. According to an AISG standard, communication devices are largely divided into a primary station and a secondary station. The primary station part refers to a master part being installed in the base station main body and transmitting a control signal such as MCU, and the secondary station refers to a slave part being installed in the base station antenna side such as RET and an ALD modem and receiving a control signal and performing an operation based on the control signal.

As described above, recently, there is a trend in which the base station antenna system has a more complex structure such as a multiple-antenna structure. Many other devices may be additionally installed in the base station antenna system such as a remote wireless device which is installed in the base station antenna part, and various ALDs which are installed inside of the base station antenna system. Therefore, since a number of failures may occur in each device and components inside the device, being installed in a wireless communication system including a base station antenna, measures for keeping the quality of the mobile communication service most stably have been required. In addition, measures for more efficiently controlling various device installed in a wireless communication system including a base station antenna have been required.

### SUMMARY

Therefore, a purpose of the present invention is to provide a wireless high-frequency signal path forming device and a method for controlling the same which can most stably maintain the quality of a mobile communication service by a base station antenna.

Another purpose of the present invention is to provide a wireless high-frequency signal path forming device and a method for controlling the same which can more efficiently control a device to be installed in a base station antenna.

According to an aspect of the present invention for achieving the above objects, there is provided a wireless high-frequency signal path forming device. The device may include: a plurality of output ends connected so as to correspond to a plurality of antenna arrays, respectively; a plurality of input ends connected so as to correspond to a plurality of amplifiers, respectively; a switching module for forming a path for variably connecting each of the plurality of input ends to one output end selected from the plurality of output ends according to a switching control signal; and a controller for receiving an external command and outputting a switching control signal for controlling a switching operation of the switching module according to the external command.

According to another aspect of the present invention, there is provided a method for controlling a path forming device which is a secondary device for performing a control operation by transmitting/receiving a High-level Data-Link Control (HDLC) message based on an Antenna Interface Standards Group (AISG) standard to/from a primary device. The method may include: receiving the HDLC message from the primary device; extracting a predetermined device address and a procedure ID from the received HDLC messages; checking whether the extracted procedure ID is a procedure ID preconfigured with respect to a path configuration between multiple input ends and multiple output ends provided in the path forming device; performing an operation of configuring a path between the multiple input ends and output ends according to the checked procedure ID; and reporting a result of the performance of the operation to the primary device through a response message.

### BRIEF DESCRIPTION OF DRAWINGS

FIGS. 1A and 2A are exemplary block diagrams illustrating a connection state between a base station antenna and remote wireless device which can be considered in connection with the present invention, and FIGS. 1B and 2B are graphs illustrating radiation characteristics according to a connection state of FIGS. 1A and 2A;

FIG. 3A is a block diagram showing a connection state between a base station antenna and a remote wireless device according to an embodiment of the present invention, and FIG. 3B is a graph showing radiation characteristics of FIG. 3A;

FIGS. 4A, 4B and 4C are schematic block diagrams of a wireless high-frequency signal path forming device provided on a base station antenna according to a first embodiment of the present invention;

FIG. 5 is a schematic block diagram of a wireless high-frequency signal path forming device provided on a base station antenna according to a second embodiment of the present invention;

FIG. 6 is a schematic block diagram of a wireless high-frequency signal path forming device provided on a base station antenna according to a third embodiment of the present invention;

FIG. 7A and FIG. 7B are schematic block diagrams of a wireless high-frequency signal path forming device provided on a base station antenna according to a fourth embodiment of the present invention;

FIG. 8 is a schematic block diagram of a wireless high-frequency signal path forming device provided on a base station antenna according to a fifth embodiment of the present invention;

FIG. 9A and FIG. 9B are schematic block diagrams of a wireless high-frequency signal path forming device provided on a base station antenna according to a sixth embodiment of the present invention;

FIGS. 10A, 10B, 10C, and 10D are schematic block diagrams of a wireless high-frequency signal path forming device provided on a base station antenna according to a seventh embodiment of the present invention;

FIG. 11 is a schematic block diagram of a wireless high-frequency signal path forming device provided on a base station antenna according to an eighth embodiment of the present invention;

FIG. 12A and FIG. 12B are schematic block diagrams of a wireless high-frequency signal path forming device provided on a base station antenna according to a ninth embodiment of the present invention;

FIGS. 13A, 13B, and 13C are schematic block diagrams illustrating various installation states of a wireless high-frequency signal path forming device according to various embodiments of the present invention;

FIG. 14 is a schematic block diagram of a wireless high-frequency signal path forming device provided on a base station antenna according to a tenth embodiment of the present invention;

FIG. 15 is an exemplary format diagram of a device address that is configured for a secondary device in order to control a wireless high-frequency signal path forming device according to an embodiment of the present invention;

FIG. 16A and FIG. 16B are exemplary format diagrams of procedures configured for a secondary device in order to control a wireless high-frequency signal path forming device according to an embodiment of the present invention;

FIG. 17 is an exemplary format diagram of a transmission frame between a primary device and a secondary device in order to control a wireless high-frequency signal path forming device according to an embodiment of the present invention;

FIG. 18A, FIG. 18B, FIG. 18C, and FIG. 18D are examples for values configured to an information field among transmission frames between a primary device and a secondary device in order to control a wireless high-frequency signal path forming device according to an embodiment of the present invention; and

FIG. 19 is a flow chart for the control of a wireless high-frequency signal path forming device according to an embodiment of the present invention.

### DETAILED DESCRIPTION

Hereinafter, an exemplary embodiment according to the present invention will be described in detail with reference to the accompanying drawings. In the following description, identical elements are provided with an identical reference numeral where possible. Various specific definitions found in the following description are provided only to help general understanding of the present disclosure, and it is apparent to those skilled in the art that the present disclosure can be implemented without such definitions.

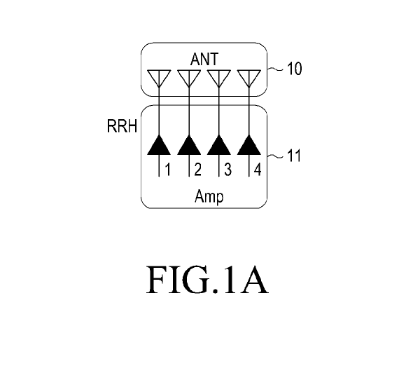

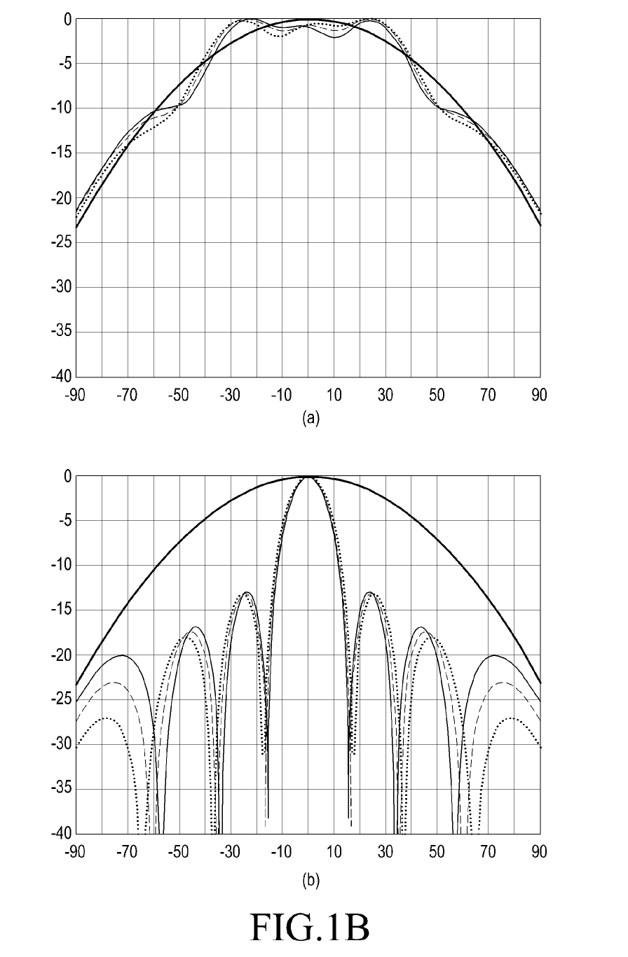

FIG. 1A is an exemplary block diagram showing a schematic connection state between a base station antenna having a multiple antenna structure and a remote wireless device that can be considered in connection with the present invention, and FIG. 1B is a graph showing radiation characteristics of the base station antenna according to the connection state of FIG. 1A. Referring to FIG. 1A, a base station antenna 10, for example, having sequentially installed four antenna arrays and performing beam forming function, is illustrated in FIG. 1A. In addition, a remote wireless device (e.g., RRH) 11 is provided outside of the base station antenna 10, the RRH includes amplifiers for amplifying, with high power, a wireless transmission signal supplied to each of the four antenna arrays, the amplifiers may include for example, amplifiers 1, 2, 3, and 4, and each of the amplifiers is connected so as to correspond to the sequentially installed four antenna arrays, respectively. At this time, beam forming radiation characteristics at the base station antenna having the above structure can be illustrated as shown in FIG. 1B, and (a) of FIG. 1B illustrates the radiation characteristics of a broadcast beam, and (b) of FIG. 1B illustrates the radiation characteristics of a service beam.

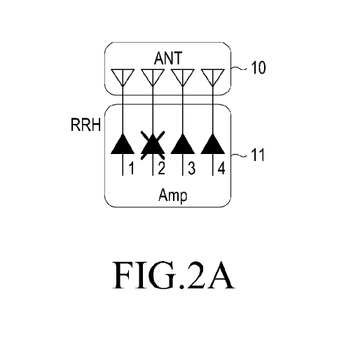

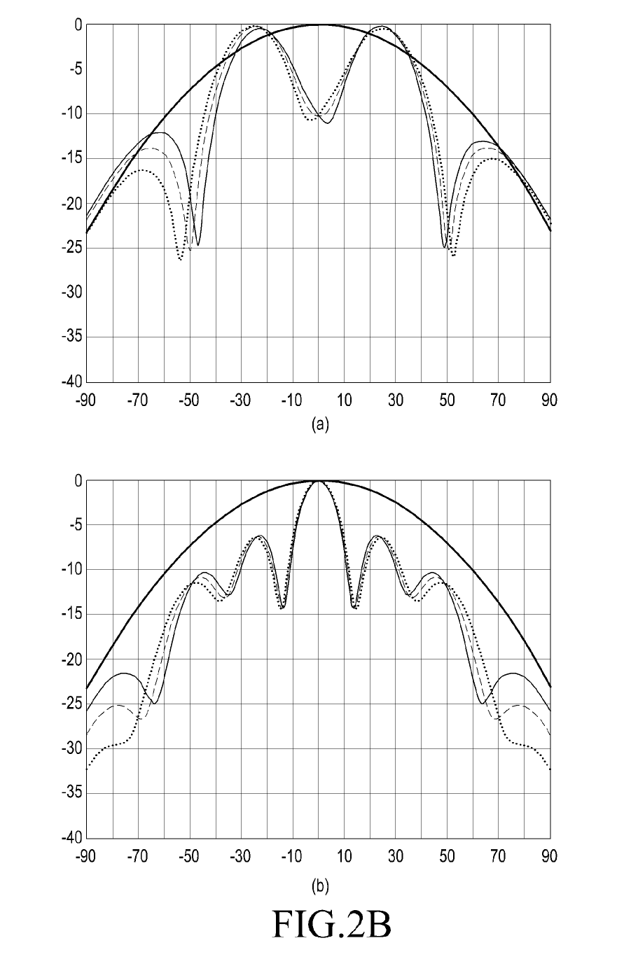

In the structure shown in FIG. 1A, for example, a case where the amplifier 2 in the remote wireless device 11 is in a failed state (or off) is shown in FIG. 2A, and the radiation characteristics of the base station antenna in such a case is shown in FIG. 2B. (a) of FIG. 2B shows the radiation characteristics of the broadcast beam, and (b) of FIG. 2B shows the radiation characteristics of the service beam. As shown in FIG. 2B, it can be seen that overall radiation characteristics of the base station antenna has a very poor side lobe characteristics, low directivity, and very poor service quality.

As the high power amplifier is one of components having relatively frequent failures, it is likely to cause the above problems according to the failure of the component. To prepare for such a case, a structure may be considered, in which at least one redundant amplifier is added by employing a redundant structure. However, if a component expected to fail is configured as a redundant structure, the structure becomes more complicated, and especially, in the case of an amplifier and a relatively expensive component, the redundant structure is not preferable in terms of cost-effectiveness.

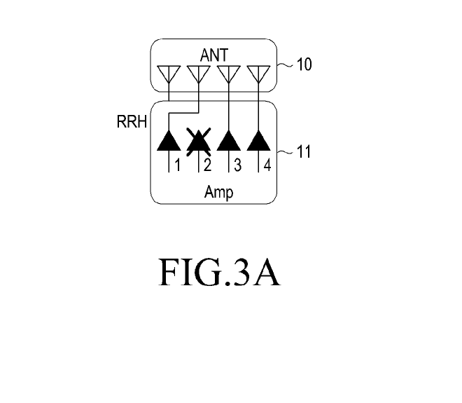

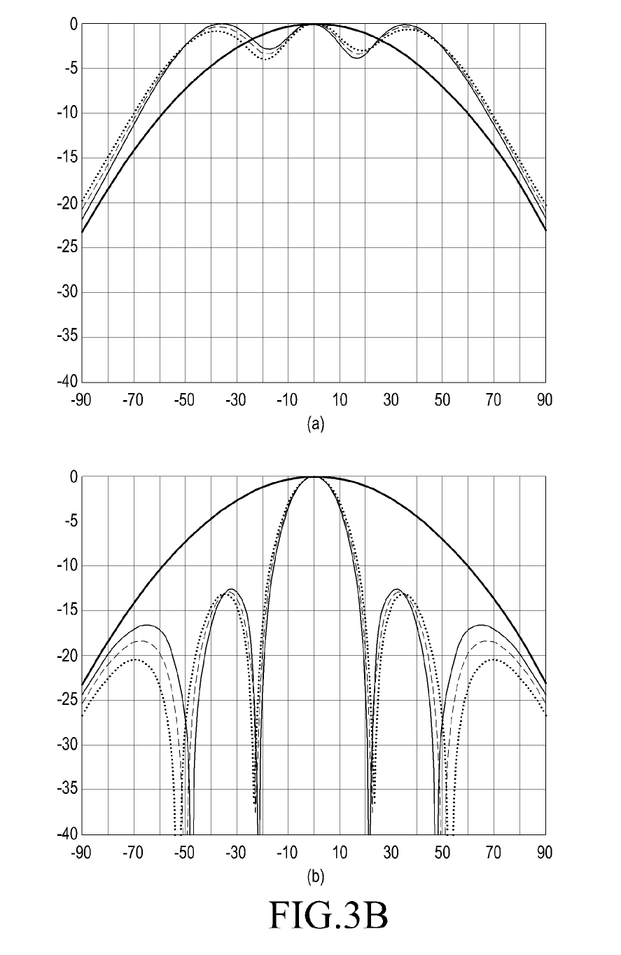

Accordingly, in an embodiment of the present invention, as shown in FIG. 3A, a structure of changing a connection path between each of the amplifiers and a multiple antenna array is proposed. FIG. 3A shows a structure for connecting an output path of an amp 1 to a second antenna array in a state where an amplifier 2 has failed (or off) in the remote wireless device 11, and FIG. 3B shows the radiation characteristics of the base station antenna in the structure of FIG. 3A. (a) of FIG. 3B shows the radiation characteristics of the broadcast beam, and (b) of FIG. 3B shows the radiation characteristics of the service beam.

The structure shown in FIG. 3A is a structure for changing the path of the wireless high-frequency signal, so as to operate an antenna array located as close to the center as possible while maintaining a sequential arrangement state of the antenna array operating when an amplifier has failed (that is, when a wireless high-frequency signal provided to a particular antenna array is blocked). As shown in FIG. 3B, although the first antenna array arranged in the outermost area is not operated, the overall radiation characteristics maintains center-directivity, and thus it can be seen that the overall radiation characteristics of the base station antenna is relatively good. That is, in an embodiment of the present invention, when applying the structure for changing the path of the wireless high-frequency signal, based on the concept as illustrated in FIG. 3A, it can be found that the service quality at the base station antenna can be maintained as much as possible. Accordingly, when the structure according to the present invention is employed, a somewhat satisfactory service can be provided until defective components or devices are replaced or even in some cases when the defective components or devices are not replaced.

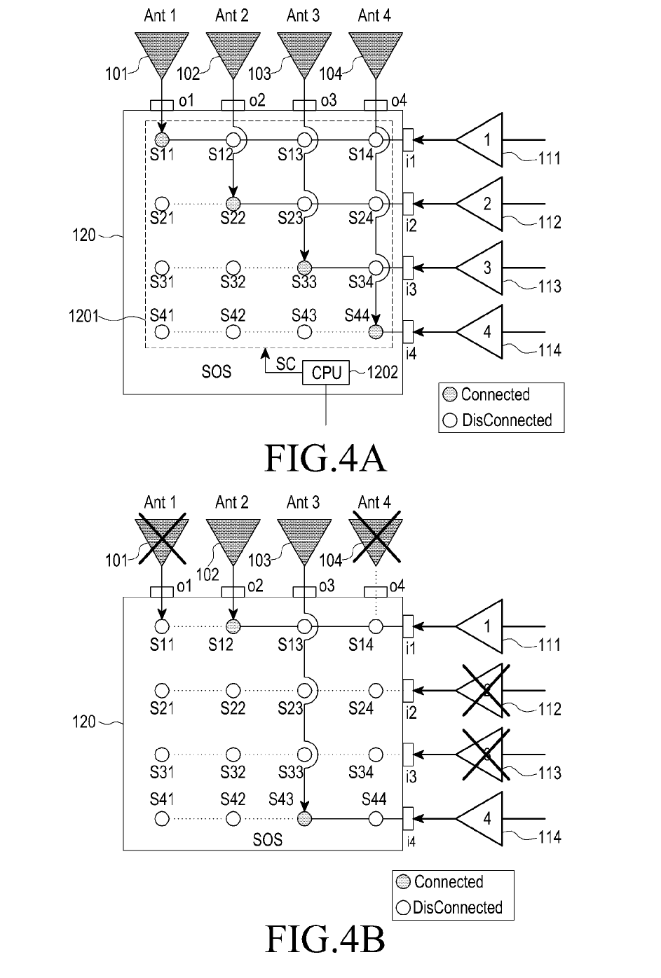

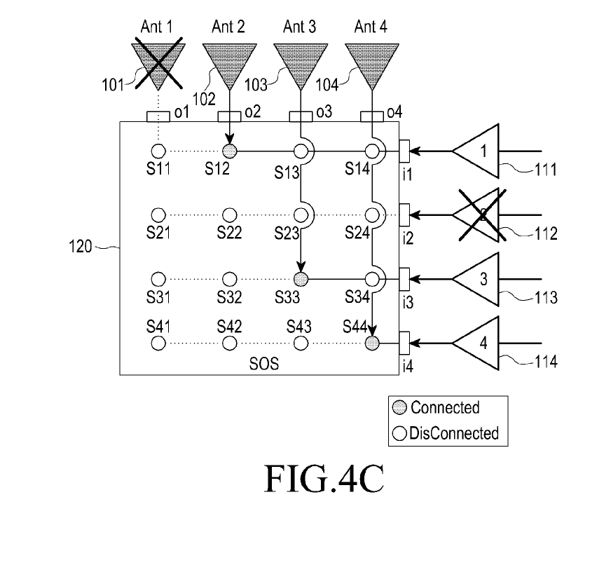

FIGS. 4A, 4B, and 4C are schematic block diagrams of a wireless high-frequency signal path forming device provided to the base station antenna having a multiple antenna structure, according to a first embodiment of the present invention, and FIG. 4A illustrates a normal state, FIG. 4B illustrates a state where second and third amplifiers have failed, and FIG. 4C illustrates a state where the second amplifier has failed. At first, referring to FIG. 4A, according to a first embodiment of the present invention, a wireless high-frequency signal path forming device 120 is provided between: sequentially installed multiple antenna arrays, for example, first, second, third and fourth antenna array 101, 102, 103, and 104; and a plurality of amplifiers i.e., the first, second, third and fourth amplifiers 111, 112, 113, and 114 for amplifying, with high power, wireless high-frequency signals are individually provided to the first to fourth antenna arrays 101 to 104, so as to appropriately change and configure, by external control, each path of the wireless high-frequency signals. At this time, the path forming device 120 will be referred to as a ‘Switching Override System (SOS)’.

The first to fourth amplifiers 111, 112, 113, and 114 may be elements to be provided in the remote wireless device, such as TMA, BTS, a base station, RRH, etc. In addition, the first to fourth antenna arrays (101 to 104) may be antenna arrays for forming a beam forming antenna structure.

The path forming device 120 includes: a plurality of output ends, that is, first to fourth output ends o1, o2, o3, and o4 connected so as to correspond to the first to fourth antenna arrays 101 to 104, respectively; a plurality of input ends, that is, first to fourth input ends i1, i2, i3, and i4 connected so as to correspond to the first to fourth amplifiers 111 to 114, respectively; and a switching module 1201 for variably connecting each of the first to fourth input ends i1 to i4 to one output end selected among the first to fourth output ends o1 to o4 according to a switching control signal SC. In addition, the path forming device 120 includes a controller (e.g., CPU) 1202 that receives a command from outside, analyzes the command, and outputs a switching control signal SC for controlling a switching operation of the switching module 1201 according to the command.

The switching module 1201 may be formed with the 1-1st to 1-4th switching points S11, S12, S13, and S14 which connect a first input end i1 to one of first to fourth output ends o1 to o4 and disconnect the connected path; 2-1st to 2-4th switching points S21, S22, S23, and S24 which connect a second input end i2 to one of first to a fourth output ends o1 to o4 and disconnect the connected path; 3-1st to 3-4th switching points S31, S32, S33, and S34 which connect a third input end i3 to one of first to fourth output ends o1 to o4 and disconnect the connected path; and 4-1st to 4-4th switching points S41, S42, S43, and S44 which connect a fourth input i4 to one of first to fourth output ends o1 to o4 and disconnect the connected path.

In FIG. 4A, the connection status of the switching points is shown, in which signals input to the first to fourth input ends i1-i4 are provided to the first to fourth output ends o1 to o4, respectively. Accordingly, each of the signals output from the first to fourth amplifiers 111 to 114 is provided to first to fourth antenna arrays 101 to 104.

In the structure shown in FIG. 4A, for example, a state where the second and third amplifiers 112 and 113 have failed (or off) is shown in FIG. 4B. FIG. 4B has omitted a representation of the switching module 1201 and controller 1202 shown in FIG. 4A for the convenience of explanation. As shown in FIG. 4B, when the second and third amplifiers 112 and 113 have failed, and if the switching state of the internal switching points of the path forming unit 120 as shown in FIG. 4A is maintained, the providing of the wireless high-frequency signal provided to the second and third antenna arrays 102 and 103 located at the center in the entire antenna structure is stopped. To change the above state, as shown in FIG. 4B, the switching state of the switching points is changed so as to form a path connecting the first input end i1 and the second output end o2, and the switching state of the switching points is changed so as to form a path connecting the fourth input end i4 and the third output end o3. In this case, the path connecting between the second end i2 and the third input end i3 is disconnected. Accordingly, a wireless high-frequency signal is provided toward the second and third antenna arrays 102 and 103 located at the center in the entire antenna structure, and the first and fourth antenna arrays 101 and 104 located at the outer side the entire antenna structure are not operated.

As shown in FIG. 4B, in a case where the second and third amplifiers 112 and 113 have failed, in order to operate the second and third antenna arrays 102 and, 103 located at the center in the entire antenna structure, unlike the state as illustrated in FIG. 4B, in the path forming device 120, for example, a path can be formed to enable the first input end i1 and the third output end o3 to be connected and the fourth input end i4 and the second output end o2 to be connected. However, the above case may be undesirable when considering the path length and characteristics of the wireless high-frequency signal in a design of a switch structure in reality, and the switching between the signal path and the closest antenna array may be desirable.

Meanwhile, a state where only the second amplifier 112 has failed (or off) in the structure shown in FIG. 4A, is shown in FIG. 4C. As shown in FIG. 4C, when the second amplifier 112 has failed, as shown in FIG. 4C, the switching state of the switching points is changed so as to form a path connecting the first input end i1 and the second output o2, and an existing path between the second input i2 and the second output o2 is disconnected.

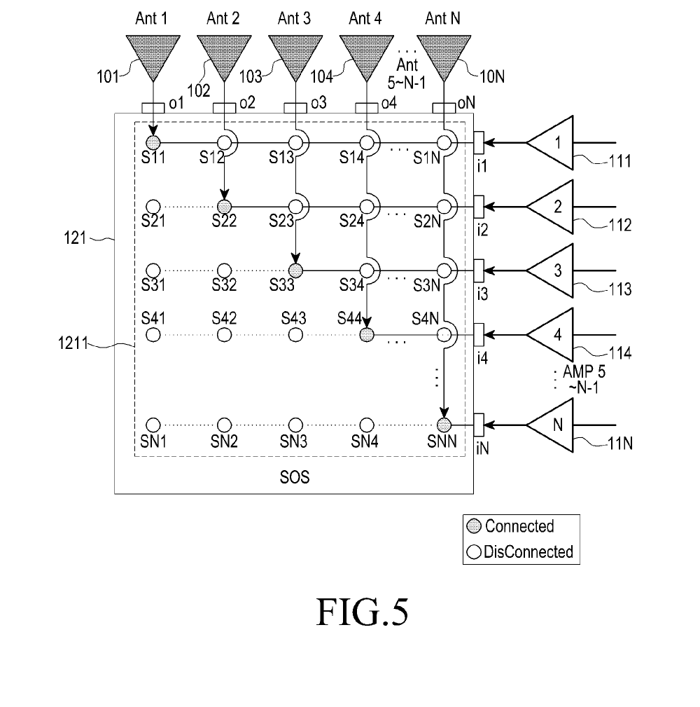

FIG. 5 is a schematic block diagram of a wireless high-frequency signal path forming device provided on a base station antenna having a multiple antenna structure according to a second embodiment of the present invention. FIG. 5 shows an example of N number of antenna arrays greater than four. Further, in FIG. 5, a normal state, that is, an example where all amplifiers are in a normal state (an initial state) is shown.

As shown in FIG. 5, a wireless high-frequency signal path forming device 121 according to a second embodiment of the present invention is provided between: sequentially installed multiple antenna arrays, for example, first, second, third, fourth, . . . , Nth antenna arrays 101, 102, 103, 104, . . . , 10N; and a plurality of amplifiers, for example, the first, second, third, fourth, and Nth amplifiers 111, 112, 113, 114, and 11N for amplifying, with high power, wireless high-frequency signals individually provided to the first to Nth antenna arrays 101 to 10N, so as to appropriately change and configure, by external control, each path of the wireless high-frequency signals.

The path forming device 121 includes: a plurality of output ends, that is, first to Nth output ends o1, o2, o3, o4, . . . , and oN connected so as to correspond to the first to Nth antenna arrays 101 to 10N, respectively; a plurality of input ends, that is, first to Nth input ends i1, i2, i3, i4, . . . , and iN connected so as to correspond to the first to Nth amplifiers 111 to 11N, respectively; and a switching module 1211 for variably connecting each of the first to Nth input ends i1 to iN to one output end selected among the first to Nth output ends o1 to oN according to a switching control signal. In addition, the path forming device 121 may include a controller (not shown) which receives a command from outside, analyzes the command, and outputs a switching control signal for controlling a switching operation of the switching module 1201 according to the command.

The switching module 1211 includes the 1-1st to 1-Nth switching points S11, S12, S13, S14, . . . and S1N for connecting a path between the first input end i1 and one output end among the first to Nth output ends of to oN, or disconnect the connected path. Similarly, 2-1st to 2-Nth switching points S21, S22, S23, S24, . . . , S2N for the second input end i2 and; 3-1st to 3-Nth switching points S31, S32, S33, . . . , S34 for the third input i3; and 4-1st to 4-Nth switching points S41, S42, S43, S44, . . . , S4N for the fourth input end i4, N-1th to N-Nth switching points SN1, SN2, SN3, SN4, . . . , SNN for the Nth input end iN, and the like can be formed.

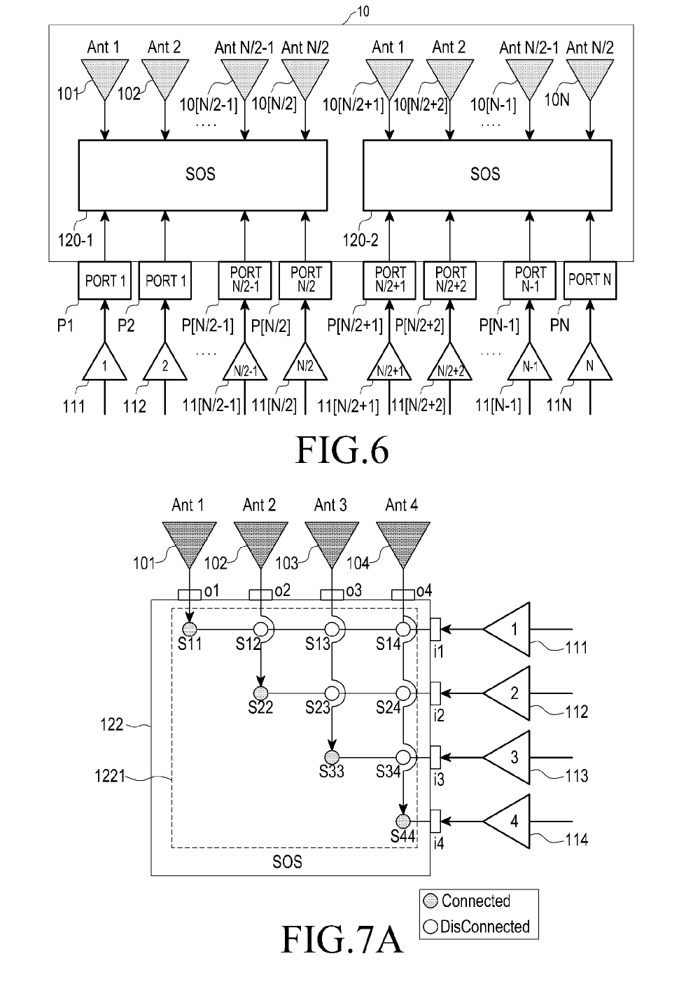

FIG. 6 is a schematic block diagram of a wireless high-frequency signal path forming device provided on a base station antenna having a multiple antenna structure according to a third embodiment of the present invention. FIG. 6 shows an example of N number of antenna arrays like FIG. 5. In addition, in the example of FIG. 6, the path forming device is designed to be divided into two sub-devices, that is, a first sub-path forming device 120-1, and a second sub-path forming device 120-2. Further, in FIG. 6, an example where the first and second sub-path forming devices 120-1 and 120-2 are mechanically installed inside the base station antenna 10 is illustrated.

An overall appearance of the base station antenna 10 is formed through a radome which corresponds to the conventional mechanical outer cover, an upper cap, and a lower cap, and the plurality of antenna arrays 101-10N can be installed therein. At this time, the lower cap includes a plurality of input and output ports for inputting and outputting the wireless high-frequency signal, a control signal, etc., and the first and second sub-path forming devices 120-1 and 120-2 may be configured to receive output signals from the first to Nth amplifiers 111 to 11N through the first to Nth ports P1 to PN. In addition, in this case, the first to Nth amplifiers 111 to 11N may be provided in the remote wireless device which is installed at the front end of the base station antenna 10.

The whole N number of antenna arrays 101 to 10N may be divide into two groups, and the first sub-path forming device 120-1 may be configured to be in charge of, for example, first to N/2th antenna arrays 101 to 10[N/2] disposed on the left part, and the second sub-path forming device 120-2 may be configured to be in charge of a [N/2+1]th to Nth antenna arrays 10[N/2+1] to 10N disposed on the right part of the whole N number of antenna arrays 101 to 10N.

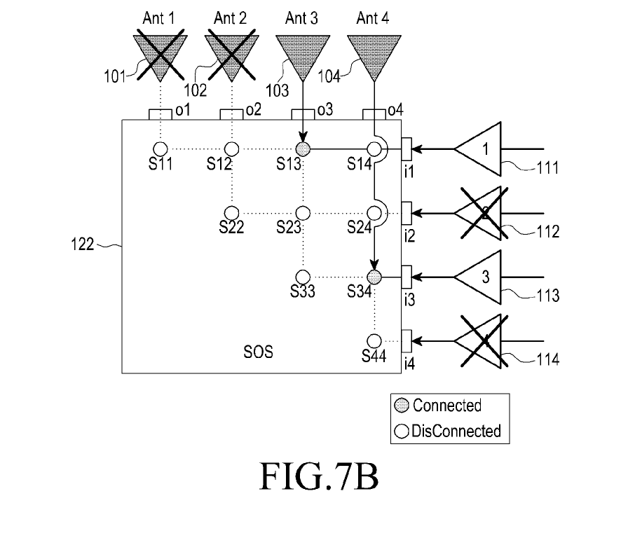

In the structure shown in FIG. 6, when N=8, that is, the total number of antenna arrays is eight, the first and second sub-path forming devices 120-1 and 120-2 are in charge of four antenna arrays each. In addition, in such a case, it will be appreciated that the first and second sub-path forming devices 120-1 and 120-2 may have the same structure as the path forming device 120 according to the first embodiment as shown in the FIG. 4A. Alternatively, the first and second sub-path forming devices 120-1 and 120-2 may have a structure similar to that of a path forming device 122 according to a fourth embodiment shown in FIG. 7A.

FIGS. 7A and 7B are schematic block diagrams of a wireless high-frequency signal path forming device provided on the base station antenna having a multiple antenna structure, according to a fourth embodiment of the present invention, and FIG. 7A illustrates a normal state, and FIG. 7B illustrates a state where second and third amplifiers have failed. A path forming device 122 according to a fourth embodiment of the invention shown in FIGS. 7A and 7B 122 may have the same structure as, for example, the case where the first sub-path forming device 120-1 shown in FIG. 6 is in charge of four antenna arrays.

The above embodiments have been described that, when any amplifier has failed, the path between the amplifiers and the plurality of antenna arrays is changed and configured so as to maintain the operation of the antenna arrays possibly-located in the center among a plurality of antenna arrays. In this case, for example, an antenna array disposed on the outermost area (that is, the first antenna array) may not necessarily be connected to an amplifier other than an amplifier (first amplifier) having a path connected thereto. A structure according to the fourth embodiment of the present invention shown in FIGS. 7A and 7B shows an example that can be applied to the above case.

At first, referring to FIG. 7A, when describing a configuration of the path forming device 122 according to the fourth embodiment of the present invention in more detail, the path forming device 122, like the configuration of the previous embodiments, is provided between sequentially installed first, second, third and fourth antenna arrays 101, 102, 103, and 104 and first, second, third and fourth amplifiers 111, 112, 113, and 114 for amplifying, with high power, wireless high-frequency signals individually provided to the first to fourth antenna arrays 101 to 104, so as to appropriately change and configure, by an external control, each of the paths of the wireless high-frequency signals. In addition, the path forming unit 122 includes: first to a fourth output ends o1, o2, o3, and o4 connected so as to correspond to the first to fourth antenna arrays 101 to 104, respectively; first to a fourth input ends i1, i2, i3, and i4 connected to correspond to the first to fourth amplifiers 111 to 114, respectively; and a switching module 1221 for variably connecting each of the first to fourth input ends i1 to i4 to one output end selected from the first to fourth output ends o1 to o4 according to a switching control signal. In addition, the path forming device 120 may include a controller (not shown) which receives a command from outside, analyzes the command, and outputs a switching control signal for controlling a switching operation of the switching module 1221 according to the command.

At this time, referring to the detailed configuration of the switching module 1221, unlike the previous embodiments, the switching module 1221 may be formed with: 1-1st to 1-4th switching points S11, S12, S13, and S14 which connect a first input end i1 to one of first to fourth output ends o1 to o4 and disconnect the connected path; 2-2nd to 2-4th switching points S22, S23, and S24 which connect a second input end i2 to one of second to fourth output ends o2 to o4 and disconnect the connected path; 3-3rd and 3-4th switching points S33 and S34 which connect a third input end i3 to either a third or fourth output ends o3 and o4 and disconnect the connected path; and a 4-4th switching point S44 which connects a fourth input i4 to a fourth output end o4 and disconnect the connected path.

In the structure shown in FIG. 7A, for example, the state where the second and fourth amplifiers 112 and 114 have failed (or off) is shown in FIG. 7B. FIG. 7B has omitted a representation of the switching module 1221 shown in FIG. 4A for the convenience of explanation. As shown in FIG. 7B, when the second and fourth amplifiers 112 have failed, as shown in FIG. 7B, the switching state of the switching points is changed so as to form a path connecting the first input end i1 and the third output end o3, and the switching state of the switching points is changed so as to form a path connecting the third input end i3 and the fourth output end o4. In this case, the path connecting between the second input end i2 and the fourth input end i4 is disconnected.

It can be seen that the switching state of the switching points shown in FIG. 7B is a state where a wireless high-frequency signal is provided toward the third and fourth array antennas 103 and 104 in the whole antenna structure. The switching state may be appropriate when assuming a case where the path forming device 122 according to the fourth embodiment shown in FIGS. 7A and 7B is applied to the first sub-path forming device 120-1 shown FIG. 6. It should be understood that the case is applicable when the first sub-path forming device 120-1 is in charge of four antenna arrays. In addition, it will be appreciated that the second sub-path forming device 120-2 shown in FIG. 6 also may be implemented similar to that shown in FIG. 7A.

Further, as well as the structure of the switching module 1221 shown in FIG. 7A, for example, when targeting only four antenna arrays, the switching module may be implemented by the configuration of only enabling the first input end i1 connected to the first amplifier 111 to be connected to the second output end o2, and enabling the fourth input end i4 connected to the fourth amplifier 114 to be connected to the third output end o3.

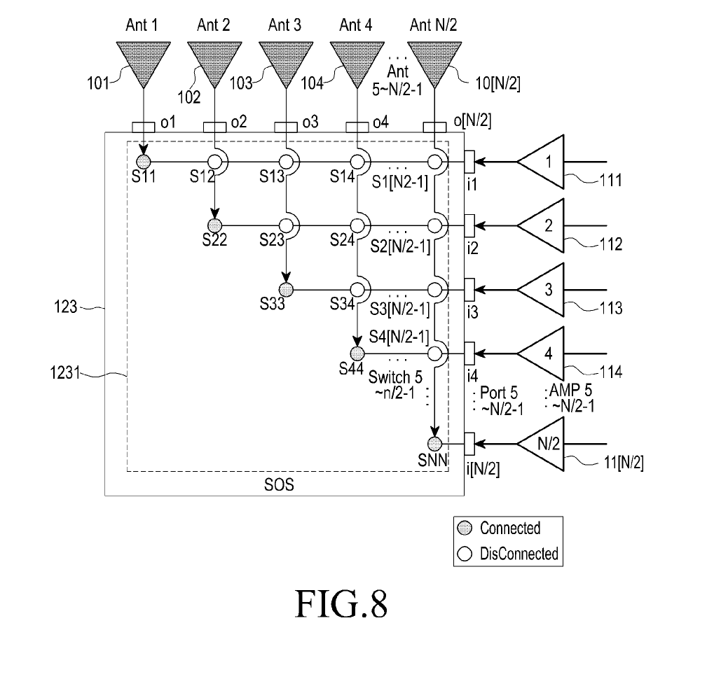

FIG. 8 is a schematic block diagram of a wireless high-frequency signal path forming device provided on a base station antenna having a multiple antenna structure according to a fifth embodiment of the present invention. FIG. 8 shows an example of N number of antenna arrays greater than four. Further, in FIG. 8, a normal state, that is, an example where all amplifiers are in a normal state (an initial state) is shown.

As shown in FIG. 8, a wireless high-frequency signal path forming device 123 according to a fifth embodiment of the present invention is provided between sequentially installed first, second, third, fourth, . . . , [N/2]th antenna arrays 101, 102, 103, 104, . . . , 10[N/2] and first, second, third, fourth, and [N/2]th amplifiers 111, 112, 113, 114, and 11[N/2] for amplifying, with high power, wireless high-frequency signals individually provided to the first to Nth antenna arrays 101 to 10[N/2], so as to appropriately change and configure by external control, each path of the wireless high-frequency signals.

The path forming device 123 includes: a plurality of output ends, that is, first to [N/2]th output ends o1, o2, o3, o4, . . . , and o[N/2] connected so as to correspond to the first to [N/2]th antenna arrays 101 to 10[N/2], respectively; a plurality of input ends, that is, first to [N/2]th input ends i1, i2, i3, i4, . . . , and i[N/2] connected so as to correspond to the first to [N/2]th amplifiers 111 to 11[N/2], respectively; and a switching module 1231 for variably connecting each of the first to [N/2]th input ends i1 to i[N/2] to one output end selected among the first to [N/2]th output ends o1 to o[N/2] according to a switching control signal. In addition, the path forming device 123 may include a controller (not shown) which receives a command from outside, analyzes the command, and outputs a switching control signal for controlling a switching operation of the switching module 1231 according to the command.

The switching module 1231 includes the 1-1st to 1-[N/2]th switching points S11, S12, S13, S14, . . . and S1[N/2] for connecting a path between the first input end i1 and one output end among the first to [N/2]th output ends o1 to o[N/2], or disconnect the connected path. In addition, the 2-2nd to 2-[N/2]th switching points S22, S23, S24, . . . , S2[N/2] for the second input end i2, and 3-3th to 3-[N/2]th switching points S33, S34, . . . , S3[N/2] for the third input i3, and 4-4th to 4-[N/2]th switching points S44, . . . , S4N for the fourth input end i4, a [N/2]th switching point SNN for the [N/2]th input end i[N/2], and the like can be formed.

The path forming device 1221 according to the fifth embodiment shown in FIG. 8 may be appropriate when assuming the case where the path forming device 1221 according to the fifth embodiment shown in FIG. 8 is applied to the first sub-path forming device 120-1 shown FIG. 6. In addition, it will be appreciated that the second sub-path forming device 120-2 shown in FIG. 6 also may be implemented similar to that shown in FIG. 8.

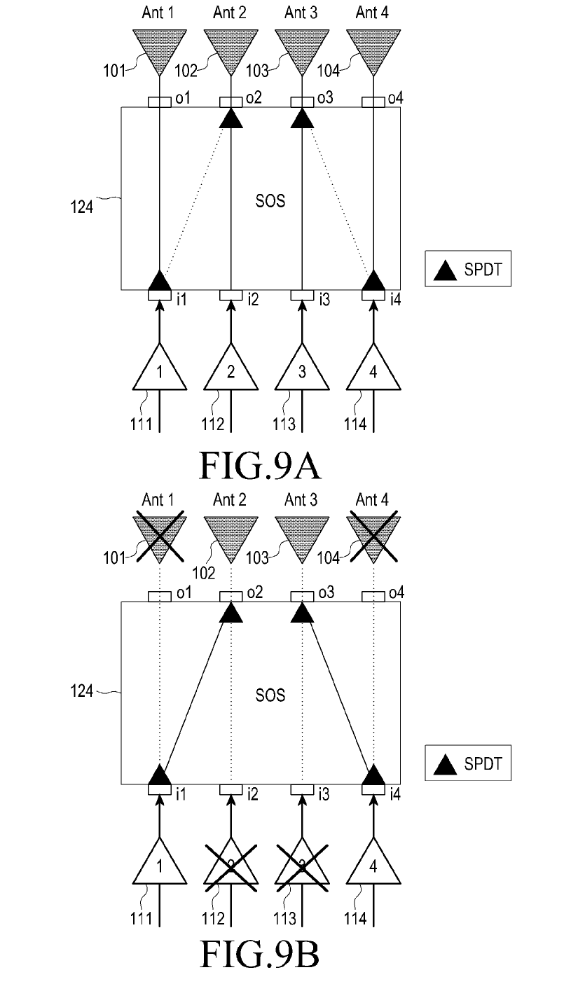

FIGS. 9A and 9B are schematic block diagrams of a device for forming a wireless high-frequency signal path provided to the base station antenna having a multiple antenna structure, according to a sixth embodiment of the present invention, wherein FIG. 9A illustrates a normal state, and FIG. 9B illustrates a state where second and third amplifiers have failed. The path forming device 124 according to a sixth embodiment of the present invention shown in FIG. 9A and FIG. 9B is similar to most of the structure of the embodiments shown in FIG. 4A or FIG. 7A, and shows a more detailed example implementable for the switching module. FIGS. 9A and 9B primarily show a detailed configuration of the switching module for the convenience of description, and omit showing the other configuration. Further, in the inside of the path forming device 124 of FIGS. 9A and 9B, the currently connected path is indicated by a solid line, and a disconnected path is indicated by a dotted line.

As shown in FIGS. 9A and 9B, the path forming device 124 according to the sixth embodiment of the present invention may be implemented as a connection structure of four Single-Pole Double Throw (SPDT) switches. That is, the path forming device 124 is provided with a switch which is installed on the first input end i1 and connects the first input end i1 to the first or second output end of or o2, and a switch which is installed on the fourth input end i4 and connect the fourth input end i4 to the third or fourth output end o3 or o4. In addition, in order to perform impedance matching between the input end and the output end, the path forming device 124 is provided with a switch which is installed on the second output end o2 and connects the second output end o2 to the first or second input end i1 or i2; and a switch which is installed on the third output end o3 and connects the third output end o3 to the third or fourth input end i3 or i4.

FIG. 9A shows the status of each of the switches such that the first to fourth input ends i1 to i4 are connected so as to correspond to the first to fourth output ends of to o4, respectively. In this situation, for example, when the second and third amplifiers 112 and 113 have failed, as shown in FIG. 9B, each of the switches may perform a switching operation of connecting the first input end i1 to the second output end o2 and connecting the fourth input end i4 to the third output end o3.

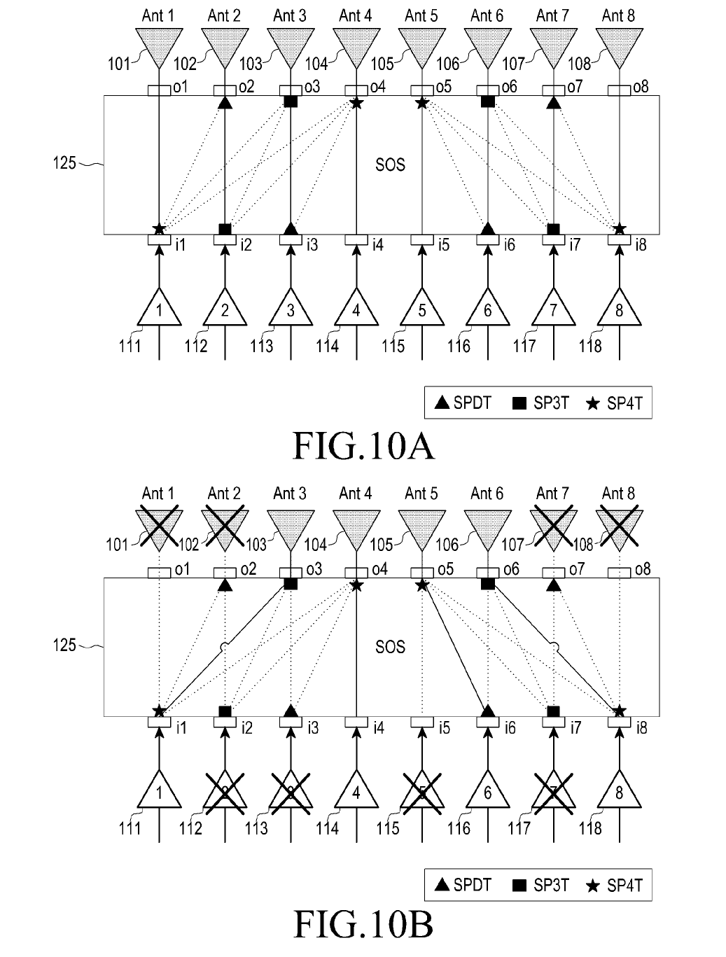

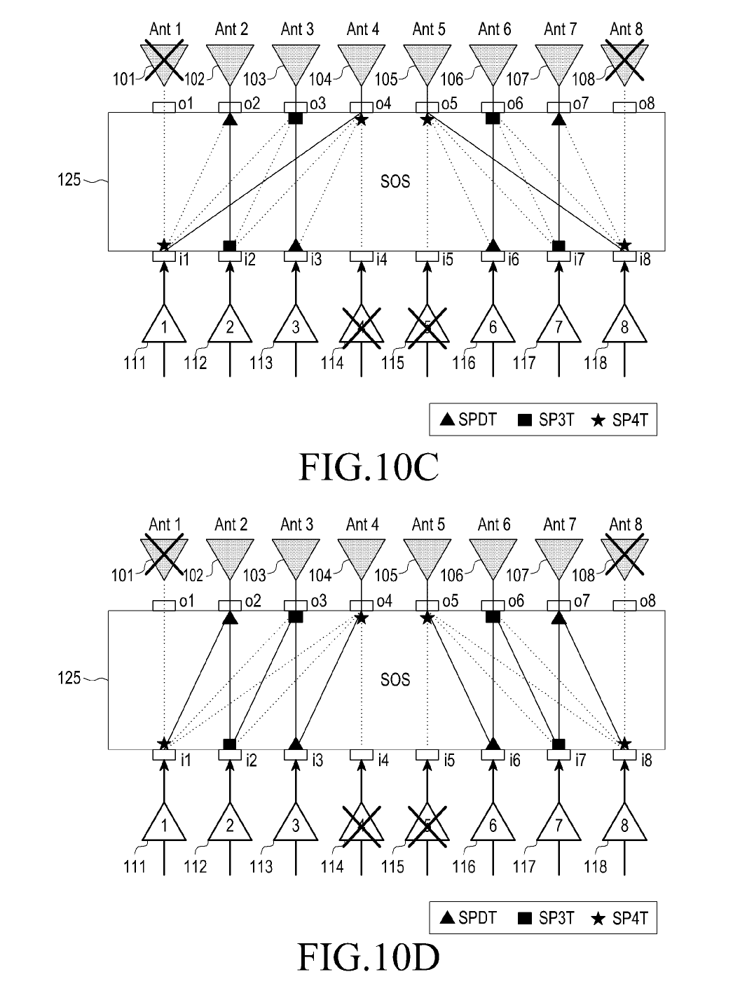

FIGS. 10A, 10B, 10C, and 10D are schematic block diagrams of a wireless high-frequency signal path forming device provided on the base station antenna having a multiple antenna structure, according to a seventh embodiment of the present invention. FIG. 10A illustrates a normal state, FIG. 10B illustrates a state where second, third, and fifth amplifiers have failed, and FIGS. 10C and 10D illustrate a state where the fourth and fifth amplifiers have failed. The wireless high-frequency signal path forming device 125, according to the seventh embodiment of the present invention shown in FIGS. 10A to 10D, is most similar to the structure of the first embodiment shown in FIG. 5 or FIG. 8 except that the number of the antenna array is eight, and shows a more detailed example implementable for the switching modules. Further, in the inside of the path forming device 125 of FIGS. 10A to 10D, the currently connected path is indicated by a solid line, and a disconnected path is indicated by a dotted line.

As shown in FIGS. 10A and 10D, the path forming device 125 may be implemented with four SPDT switches, four Single-Pole 3 Throw (SP3T) switches, and four Single-Pole 4 Throw (SP4T) switches. That is, the path forming device 125 is provided with: an SP4T switch which is installed on the first input end i1 and connects the first input end i1 to the first, second, third, or fourth output ends o1, o2, o3, or o4; an SP3T switch which is installed on the second input end i2 and connects the second input end i2 to the second, third, or fourth output ends o2, o3, or o4; an SPDT switch which is installed on the third input end i3 and connects the third input end i3 to the third or fourth output ends o3 or o4; an SP4T switch which is installed on the eighth input end i8 and connects the eighth input end i8 to the eighth, seventh, sixth, or fifth output ends o8, o7, o6, or o5; an SP3T switch which is installed on the seventh input end i7 and connects the seventh input end i7 to the seventh, sixth, or fifth output ends o7, o6, or o5; and an SPDT switch which is installed on the sixth input end i6 and connects the sixth input end i6 to the sixth or fifth output ends o6 or o5. In addition, the path forming device 125 is provided with an SP4T switch which is installed on the fourth output end o4 and connects the fourth output end o4 to the first, second, third, or fourth input ends i1, i2, i3, or i4; an SP3T switch which is installed on the third output end o3 and connects the third output end o3 to the first, second, or third input ends i1, i2, or i3; an SPDT switch which is installed on the second output end o2 and connects the second output end o2 to the first or second input ends i1 or i2; the SP4T switch which is installed on the fifth output end o5 and connects the fifth output end o5 to the fifth, sixth, seventh, or eighth input ends i5, i6, i7, or i8; the SP3T switch which is installed on the sixth input end i6 and connects the sixth output end i6 to the sixth, seventh or eighth input ends i6, i7, or i8; and the SPDT switch which is installed on the seventh output end o7 and connects the seventh output end o7 to the seventh or eighth input ends i7 or i8.

FIG. 10A shows the status of the switch such that the first to eighth input ends i1 to i8 correspond to the first to eighth output ends o1 to o8, respectively. In this situation, for example, when the second, third, and fifth amplifiers 112, 113, and 115 have failed, as shown in FIG. 10B, each of the switches may perform a switching operation of connecting the first input end i1 to the third output end o3, connecting the sixth input end i6 to the fifth output end o5, and connecting the eighth input ends i8 to the sixth output end o6. Accordingly, the third, fourth, fifth and sixth antenna arrays 103, 104, 105, or 106 located at the center thereof are implemented to maintain the operation.

In the state shown in FIG. 10A, for example, when the fourth and fifth amplifiers 114 and 115 have failed, as shown in FIG. 10C, each of the switches may perform a switching operation of connecting the first input end i1 to the fourth output end o4 and connecting the eighth input end i8 to the fifth output end o5. In addition, as shown in FIG. 10D, for example, each switch may perform a switching operation of connecting the first input end i1 to the second output end o2, connecting the second input end i2 to the third output end o3, connecting the third input end i3 to the fourth output end o4, connecting the eighth input end i8 to the seventh output end o7, connecting the seventh input end i7 to the sixth output end o6, and connecting the sixth input end i6 to the fifth output end o5.

On the other hand, when referring to the structure shown FIG. 9A to FIG. 10D, for example, in another embodiment of the invention, it can be seen that N/2 number of switches, i.e., the SP[N/2]T switch, the SP[N/2−1]T switch, . . . the SPDT switch, are required as switching elements for actually implementing the path forming device.

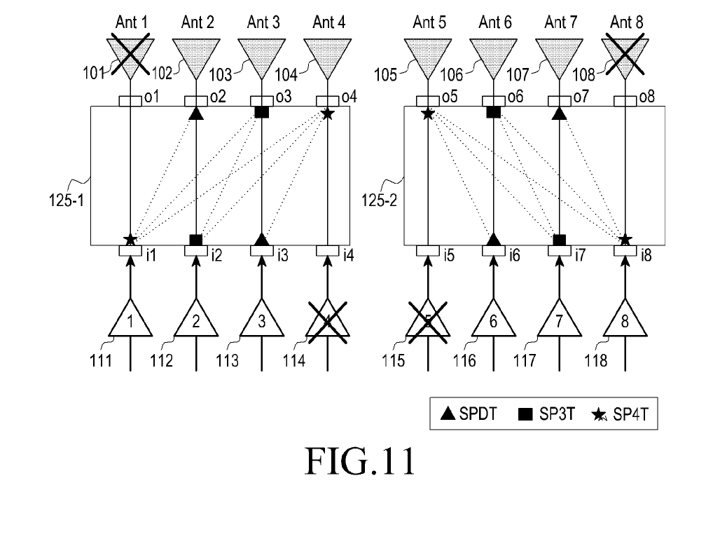

FIG. 11 is a schematic block diagram of a wireless high-frequency signal path forming device provided on a base station antenna having a multiple antenna structure according to an eighth embodiment of the present invention. The structure of a path forming device according to an eighth embodiment of the present invention shown in FIG. 11 is logically identical to that of the seventh embodiment shown in FIG. 10A to 10D, however, FIG. 11 shows a state where the path forming device is designed to be divided into two sub-devices that can be symmetrically configured, that is, a first sub-path forming device 125-1 and a second sub-path forming device 125-2. That is, the first sub-path forming device 125-1 may be configured to divide the first to eighth antenna arrays 101 to 108 into two groups, and be in charge of the first to fourth antenna arrays 101 to 104 arranged on the left side, and the second sub-path forming device 125-2 may be configured to be in charge of the fifth to eighth antenna arrays 105 to 108 arranged on the right part of the first to eighth antenna arrays 101 to 108.

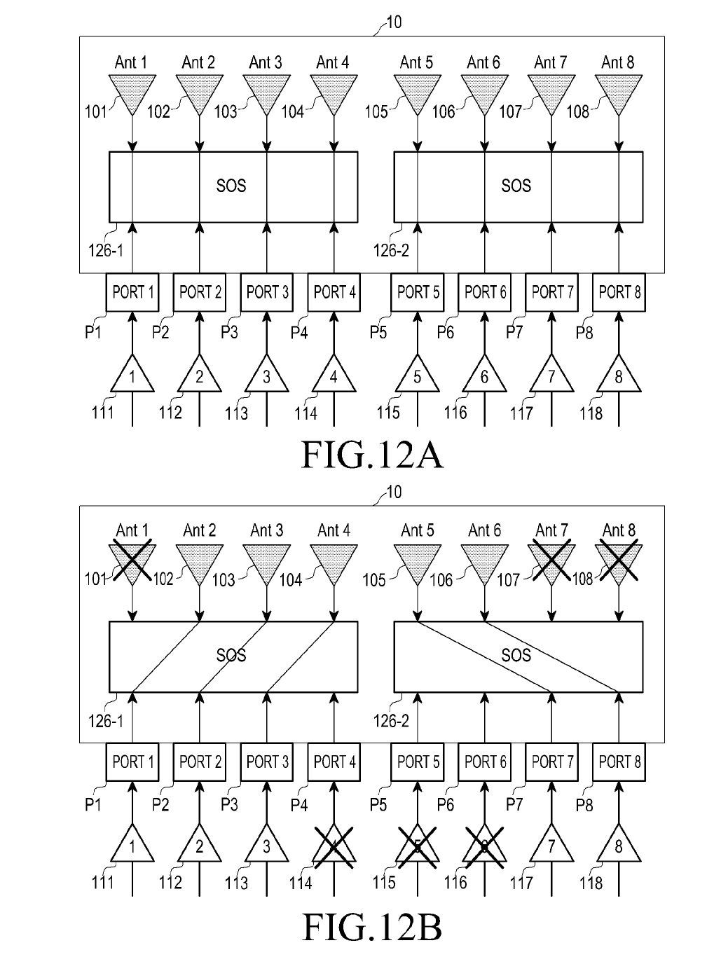

FIGS. 12A and 12B are schematic block diagrams of a wireless high-frequency signal path forming device provided on the base station antenna having a multiple antenna structure, according to a ninth embodiment of the present invention, and FIG. 12A illustrates a normal state, and FIG. 12B illustrates a state where the fourth, fifth, and sixth amplifiers have failed. The structure of a path forming device according to the ninth embodiment of the present invention shown in FIG. 12 is logically identical to that of the eighth embodiment shown in FIG. 11, however, FIG. 11 shows an example where the first and second sub-path forming devices 126-1 and 126-2 are mechanically installed inside the base station antenna 10.

For example, the first sub-path forming device 126-1 may be configured to receive output signals from the first to fourth amplifiers 111 to 114 through first to fourth ports P1 to P4 formed on the base station antenna 10, and the second sub-path forming device 126-2 may be configured to receive output signals from the fifth to eighth amplifiers 115 to 118 through a fifth to eighth ports P5 to P8 formed on the base station antenna 10.

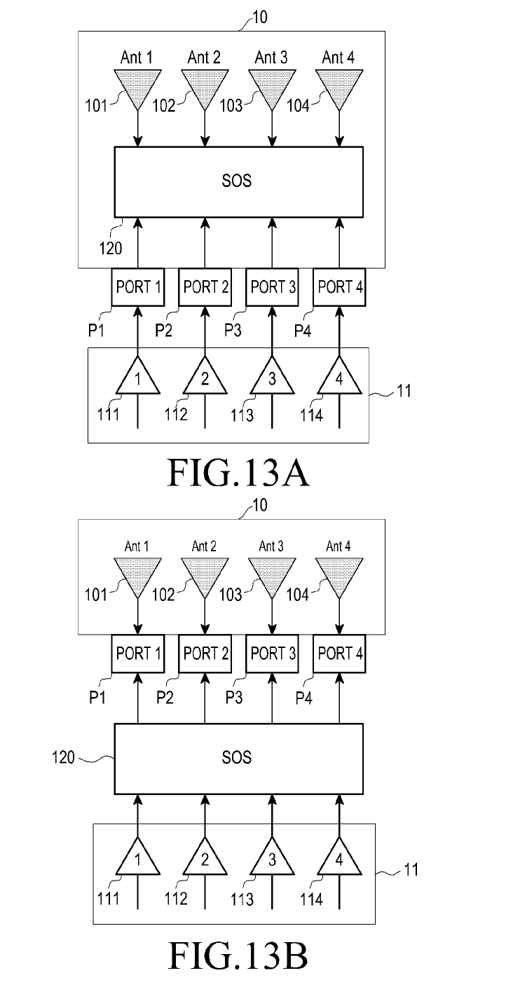

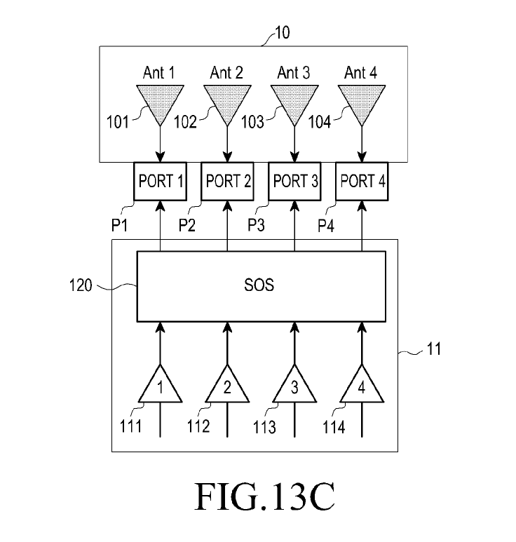

FIG. 13A, FIG. 13B and FIG. 13C are schematic block diagrams illustrating a variety of installation states of a wireless high-frequency signal path forming device provided on the base station antenna having a multiple antenna structure in accordance with embodiments of the present invention, and FIG. 13A shows a state where the path forming device 120 is mechanically installed inside the base station antenna 10, FIG. 13B shows a state where the path forming device 120 is separately installed between the base station antenna 10 and the remote wireless device 11. In addition, as shown in FIG. 13C, the path forming device 120 may also be mechanically installed inside the remote wireless device 11. That is, the most desirable case is that the path forming device 120 is installed between the antenna 10 and the amplifier on the route, and various positions such as inside the antenna, RRH, etc. are available for the mechanical installation position.

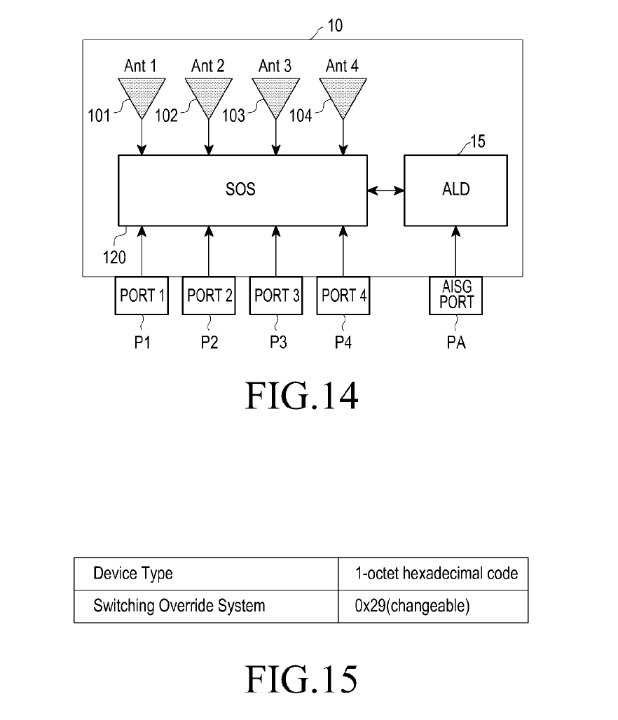

FIG. 14 is a schematic block diagram of a wireless high-frequency signal path forming device provided on the base station antenna having a multiple antenna structure in accordance with a tenth embodiment of the present invention, and the path forming device 120 shown in FIG. 14 may have the same structure as that of other embodiments, and may be installed to receive an external command for a path forming operation, for example, through another ALD 15 connected in a daisy-chain fashion through an AISG cable, etc.

On the other hand, the path forming device 120 shown in FIG. 14 is shown to be installed inside the base station antenna 10, but may also be installed outside the base station antenna 10, for example, at the front end of the base station antenna 10.

In the following description, a detailed method for performing the path forming operation, by the path forming device which can be configured as the embodiments of the present invention, according to a command provided from the outside, for example, the base station main body, will be described. At this time, the communication scheme between the path forming device and the external control device according to the present invention proposes a communication scheme which can be compatible with the AISG standard. That is, an embodiment of the present invention proposes a communication scheme in which the base station main body is considered as the primary device according to the AISG standard, and the path forming device is considered as the secondary device according to the AISG standard.

FIG. 15 is an example format diagram of a code of a device that is configured for a secondary device and handles the corresponding path forming device as the secondary device in accordance with an AISG standard, in order to control a wireless high-frequency signal path forming device according to an embodiment of the present invention. Referring to FIG. 15, at first, the path forming device according to the present invention, also known as “SOS” may have a predetermined value as device identification information, that is, a device code, for example, “0x29 [hexadecimal code]” value.

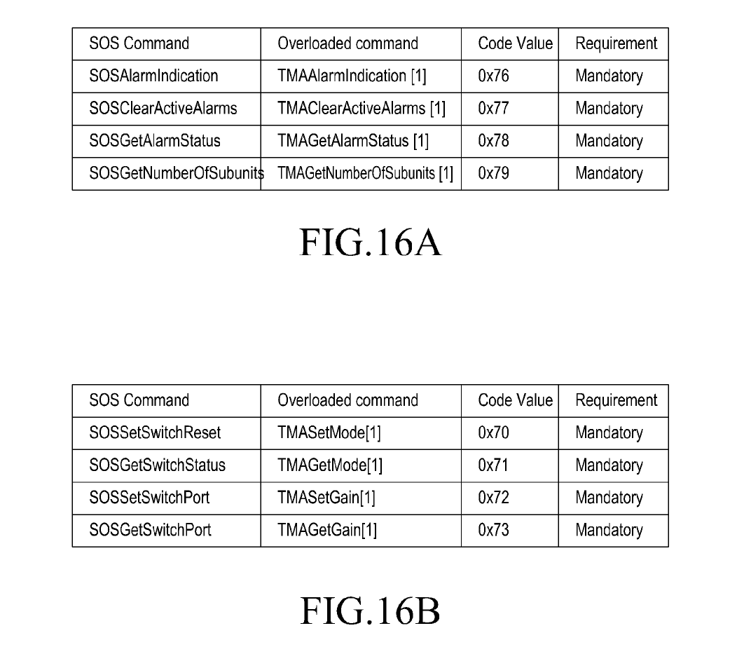

FIG. 16A and FIG. 16B are exemplary format diagrams of procedures configured for a secondary device in order to control a wireless high-frequency signal path forming device according to an embodiment of the present invention, FIG. 16A illustrates an example of procedures to be applied in the path forming device of the present invention, so as to correspond to common commands prescribed according to an AISG standard for the conventional ALD, and FIG. 16B illustrates an example of procedures corresponding to the path forming device-specific operation command according to the present invention.

First, referring to FIG. 16A, for the operation procedures such as an alarm display, an active alarm clear, alarm condition acquisition, the number of sub-units acquisition of the path forming device, etc., procedures also known as, “SOSAlarmIndication”, “SOSClearActiveAlarms”, “SOSGetAlarmStatus”, “SOSGetNumberOfSubunits”, etc. can be defined, and identification code values thereof can be defined as “0x76”, “0x77”, “0x78”, “0x79”, respectively. Respective identification code values may be used by overloading the conventionally defined TMA procedures and the identification code value thereof, in order to prevent table waste of a common command table configured in the AISG standard.

Next, referring to FIG. 16B, a procedure for instructing to set the path as the initial state, also known as “SOSSetSwitchReset” procedure, can be defined in the path forming device according to an embodiment of the present invention, and the identification code value can be defined as “0x70”. The “SOSSetSwitchReset” procedure corresponds to, for example, an operating procedure that returns all the switches to the initial value of the manufacturing process.

In addition, a procedure for instructing to notify the current path configuration state, also known as “SOSGetSwitchStatus” procedure, can be defined in the path forming device, and the identification code value may be defined as “0x71”. The “SOSGetSwitchStatus” procedure corresponds to an operation procedure for checking output ends with respect to all input ends, for example, the operation procedure of checking an output end connected to a first input end, an output end connected to a second input end, . . . , an output end connected to a Nth input end is performed.

In addition, a procedure for designating an output end connected to a particular input end, also known as “SOSSetSwitchPort” procedure, can be defined in the path forming device, and the identification code value may be defined as “0x72”. In addition, a procedure for instructing to display an output end connected to a particular input end, also known as “SOSGetSwitchPort” procedure, can be defined in the path forming device, and the identification code value may be defined as “0x73”.

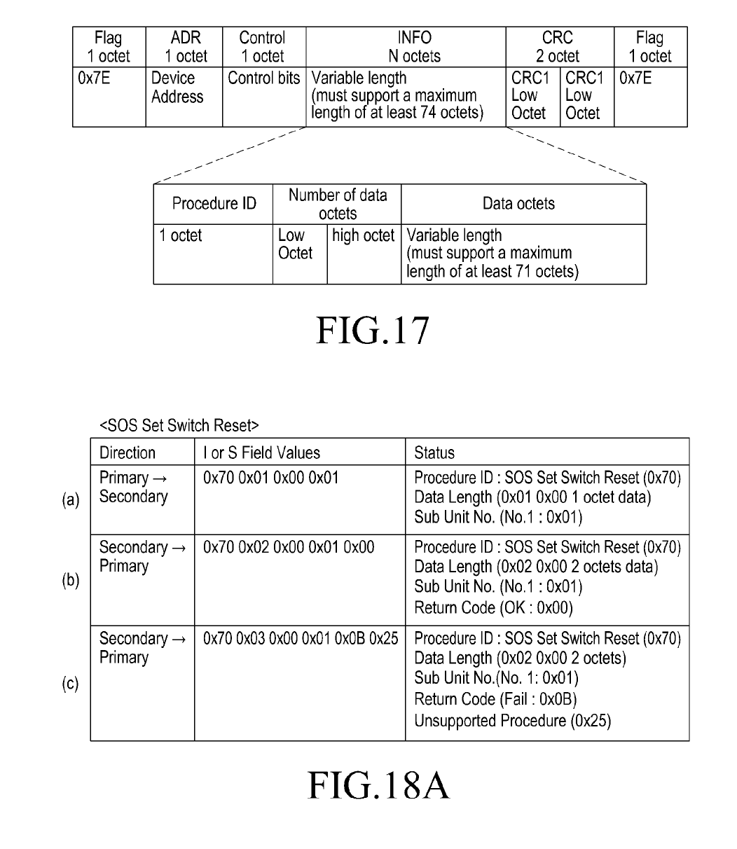

FIG. 17 is an exemplary diagram of a transmission frame between a primary device and a secondary device in order to control a wireless high-frequency signal path forming device according to an embodiment of the present invention. Referring to FIG. 17, the procedures defined as shown in FIGS. 16A and 16B can be performed by carrying out communication between the primary device and the secondary device (that is, the path forming device) through a transmission frame according to the AISG standard.

The transmission frame between the primary device and the secondary device may be set to a start flag field (Flag, one octet), an Address field (Device Address, one octet), a control fields (Control, one octet), an information field (INFO, one octet), an error correction field (CRC: two octets), and an end flag field (Flag, one octet) according to the conventional AISG standard.

In addition, the information field may be configured as a procedure ID field of one octet (Procedure ID), a frame length field of two octets (Number of data octets: low octet+high octet), and a data octet field having a variable length (Data octets). The values of the procedure ID field are configured procedure ID values as shown in FIGS. 16A and 16B.

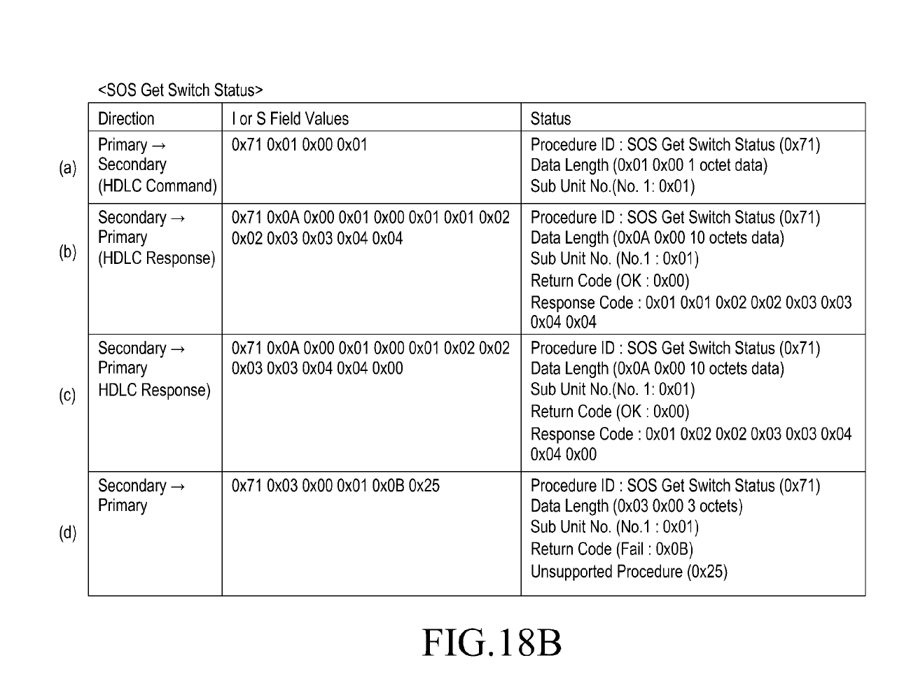

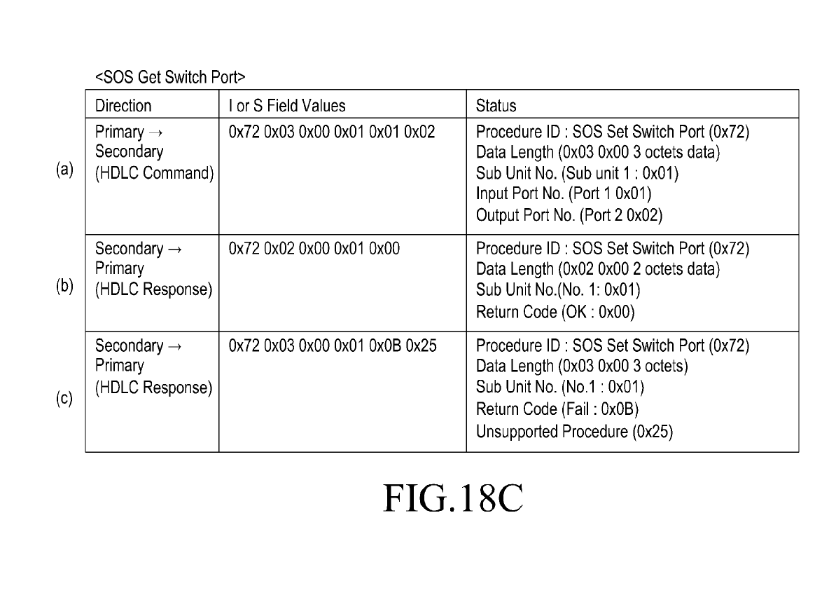

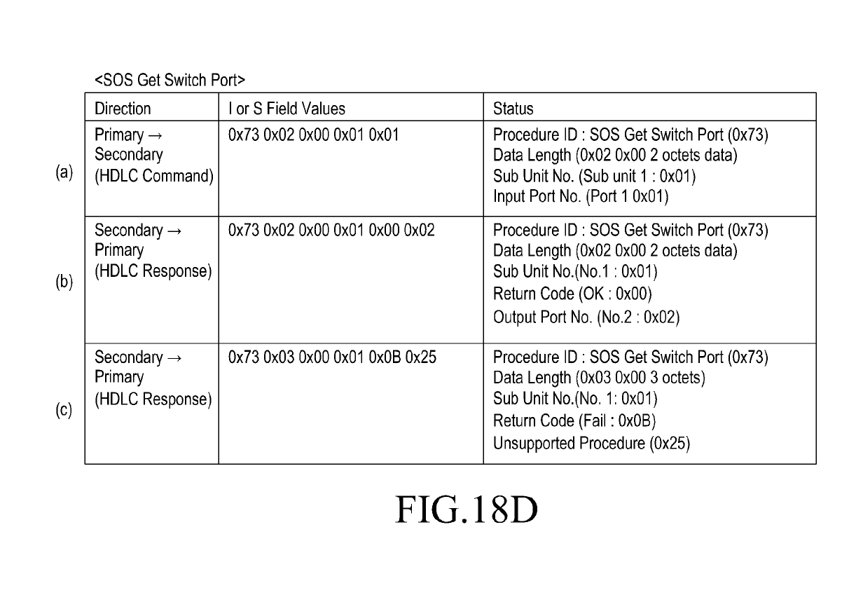

FIGS. 18A, 18B, 18C, and 18D are exemplary diagrams for values to be configured in the information field of the transmission frame between a primary device and a secondary device in order to control a wireless high-frequency signal path forming device according to an embodiment of the present invention, FIG. 18A shows an example of values associated with a “SOSSetSwitchReset” procedure, FIG. 18B shows an example of values associated with a “SOSGetSwitchStatus” procedure, FIG. 18C shows an example of values associated with a “SOSSetSwitchPort” procedure, and FIG. 18D shows an example of values associated with a “SOSGetSwitchPort” procedure.

First, referring to FIG. 18A, (a) of FIG. 18A shows an example of values of the information field corresponding to the command to perform a “SOSSetSwitchReset” procedure transmitted from the primary device to the secondary device. As shown in (a) of FIG. 18A, the information field is defined by including a procedure ID value of one octet, a frame length value of two octets, a sub-unit value of one octet, and the like. The procedure ID value is set to ‘0x70’ as shown in FIG. 16B, and the frame length value is set to ‘0x01, 0x00’ since the length of a data octet at a rear end of the corresponding frame length field is one octet. The sub-unit value is set to include one or more sub-units in the AISG standard, and accordingly the sub-unit value is set to a default value of ‘0x01’ in (a) of FIG. 18A.

(b) and (c) of FIG. 18A show examples of the information field which can be included in the response message according to a command to perform a “SOSSetSwitchReset” procedure transmitted from the secondary device to the primary device, (b) of FIG. 18A corresponds to a message notifying of the normal performance of the operation, and (c) of FIG. 18A corresponds to a message notifying of the failure in performance of the operation. As shown in (b) of FIG. 18A, the information field may be set by including a procedure ID value of one octet, a frame length value of two octets, a sub-unit value of one octet, and a return code value of one octet. In this case, the return code value may be set to, for example, “0x00” representing the normal performance of the operation (OK).

Referring to (c) of FIG. 18A, the information field for informing of a performance failure of the operation for the command to perform a “SOSSetSwitchReset” procedure may be set by including a procedure ID value of one octet, a frame length value of two octets, a sub-unit value of one octet, and a return code value of one octet. At this time, the return code value includes, for example, ‘0x0B’ of one octet representing the failure in performance of the operation (Fail). A value of at least one octet for representing more detailed information on the failure in performance of the operation may be additionally set in the return code field. For example, the value is set to “0x25” representing an unsupported procedure in (c) of FIG. 18A.

Next, referring to FIG. 18B, (a) of FIG. 18B shows an example of values of the information field corresponding to a command to perform a “SOSGetSwitchStaus” procedure transmitted from the primary device to the secondary device. As shown in (a) of FIG. 18B, the information field is defined by including a procedure ID value of one octet, a frame length value of two octets, a sub-unit value of one octet, and the like. The procedure ID value is set to ‘0x71’ as shown in FIG. 16B, and the frame length value is set to ‘0x01, 0x00’ since the length of a data octet at a rear end of the corresponding frame length field is one octet. A sub-unit value is set to the default value of ‘0x01’.

(b), (c), and (d) of FIG. 18B show examples of the information field which can be included in the response message according to a command to perform a “SOSGetSwitchStatus” procedure transmitted by the primary device from the secondary device, (b) of FIG. 18B corresponds to a message notifying of the normal performance of the operation, (c) of FIG. 18B corresponds to another example of a message notifying of the normal performance of the operation, and (d) of FIG. 18B corresponds to a message notifying of the failure in performance of the operation. As shown in (b) of FIG. 18B, the information field may be set by including a procedure ID value of one octet, a frame length value of two octets, a sub-unit value of one octet, a return code value of one octet, and response code values of multiple octets notifying of the connection state of input and output ends.

In this case, the return code value may be set to, for example, “0x00” representing the normal performance of the operation (OK). In addition, the response code value may be configured to sequentially represent input ends and output ends associated therewith. That is, in an example shown in (b) of FIG. 18B, an exemplary response code value is illustrated as ‘0x01 0x01 0x02 0x02 0x03 0x03 0x04 0x04’, which sequentially represents the first input end and an output end connected thereto (that is, the first output end), the second input end and an output end connected thereto (that is, the second output end), the third input end and an output end connected thereto (that is, the third output end), and the fourth input end and an output end connected thereto (that is, the fourth output end). In this response code, it can be seen that the current path forming device is a structure having four input/output ends corresponding to the current four array antenna.

On the other hand, (c) of FIG. 18B shows another example of a message notifying of the normal performance of the operation, unlike the example with the above-mentioned (b) of FIG. 18B, an exemplary response code value is illustrated as ‘0x01 0x02 0x02 0x03 0x03 0x04 0x00’, which represents that an output end connected to the first input end is the second output end, an output end connected to the second input end is the third output end, an output end connected to the third input end is the fourth output end, and the fourth output end is in an pen state (that is, for example, represented as ‘0x00’).

Referring to (d) of FIG. 18B, the information field for informing of a performance failure for the command to perform a “SOSGetSwitchStatus” procedure may be set by including a procedure ID value of one octet, a frame length value of two octets, a sub-unit value of one octet, and a return code value of one octet. At this time, the return code value includes, for example, ‘0x0B’ of one octet indicating the failure in performance of the operation (Fail). A value of at least one octet for representing more detailed information on the failure in performance of the operation may be additionally set in the return code field. For example, the value is set to “0x25” representing an unsupported procedure in (d) of FIG. 18B.

Next, referring to FIG. 18C, (a) of FIG. 18C shows an example of values of the information field corresponding to a command to perform a “SOSSetSwitchPort” procedure transmitted by the secondary device from the primary device. As shown in (a) of FIG. 18C, the information field is defined by including a procedure ID value of one octet, a frame length value of two octets, a sub-unit value of one octet, and input/output end individually having one octet. The procedure ID value is set to ‘0x72’ as shown in FIG. 16B, and the frame length value is set to ‘0x03, 0x00’ since the length of a data octet at a rear end of the corresponding frame length field is three octets. A sub-unit value is set to the default value of ‘0x01’. Further, values of the input end and output end are values representing the switching of a designated input end to a designated output end, and in (a) of FIG. 18C shows an exemplary value of ‘0x01 0x02’ which instructs to connect the first input end to the second input end.

(b) and (c) of FIG. 18C show examples of the information field which can be included in the response message according to the command to perform a “SOSGetSwitchStatus” procedure transmitted from the secondary device to the primary device, (b) of FIG. 18C corresponds to a message notifying that the normal operation is performed, and (c) of FIG. 18C corresponds to a message notifying of the failure in perform of the operation. As shown in (b) of FIG. 18C, the information field may be set by including a procedure ID value of one octet, a frame length value of two octets, a sub-unit value of one octet, and a return code value of one octet. In this case, the return code value may be set to, for example, “0x00” representing the normal performance of the operation (OK).

Referring to (c) of FIG. 18C, the information field for informing of a performance failure for the command to perform a “SOSGetSwitchStatus” procedure may be set by including a procedure ID value of one octet, a frame length value of two octets, a sub-unit value of one octet, and a return code value of one octet. At this time, the return code value includes, for example, a ‘0x0B’ of one octet representing the failure in performance of the operation (FAIL), and a value of at least one octet for representing more detailed information on the failure in performance of the operation may be additionally set in the return code field.

Next, referring to FIG. 18D, (a) of FIG. 18D shows an example of values of the information field corresponding to the command to perform a “SOSGetSwitchPort” procedure transmitted by the secondary device from the primary device. As shown in (a) of FIG. 18D, the information field is defined by including a procedure ID value of one octet, a frame length value of two octets, a sub-unit value of one octet, and input/output ends individually having one octet. The procedure ID value is set to ‘0x73’ as shown in FIG. 16B, and the frame length value is set to ‘0x02, 0x00’ since the length of a data octet at a rear end of the corresponding frame length field is two octets. A sub-unit value is set to the default value of ‘0x01’. Further, the value of the input end is a value for displaying an output end connected to a designated input end, and (a) of FIG. 18D shows an exemplary value of ‘0x01’ which instructs to notify of an output end connected to the first input end.

(b) and (c) of FIG. 18D show examples of the information field which can be included in the response message according to the command to perform a “SOSGetSwitchPort” procedure transmitted by the primary device from the secondary device, (b) of FIG. 18D corresponds to a message notifying that the normal operation is performed, and (c) of FIG. 18D corresponds to a message notifying of the failure in performance of the operation. As shown in (b) of FIG. 18D, the information field may be set by including a procedure ID value of one octet, a frame length value of two octets, a sub-unit value of one octet, and an output value of one octet. A value of an output end is a value for displaying an output end connected to designated input end, and in (b) of FIG. 18D shows an exemplary value of ‘0x02’ which instructs to notify that an output end connected to the first input end is the second output end.

Referring to (c) of FIG. 18D, the information field for informing of a performance failure for the command to perform a “SOSGetSwitchPort” procedure may be set by including a procedure ID value of one octet, a frame length value of two octets, a sub-unit value of one octet, and a return code value of one octet. At this time, the return code value includes, for example, a ‘0x0B’ of one octet representing the failure in performance of the operation (FAIL), and a value of at least one octet for representing more detailed information on the failure in performance of the operation may be additionally set in the return code field.

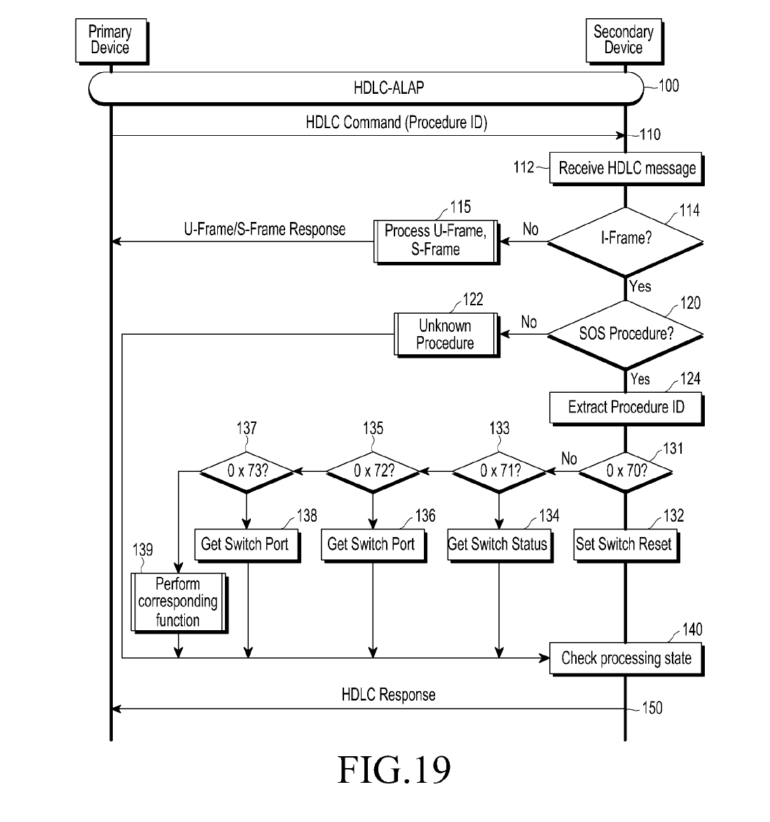

FIG. 19 is a signal flow chart for the control of a wireless high-frequency signal path forming device according to an embodiment of the present invention, in FIG. 19, the primary device may correspond to MCU, etc. of the base station main body system, and the secondary device is the path forming device in accordance with the present invention. Referring to FIG. 19, in step 100, an initial access operation between the primary and secondary devices is performed according to the AISG rules, and in step 110, the primary device transmits, to the secondary device, a High-level Data-Link Control (HDLC) message for an HDLC command (Procedure ID) according to the AISG rules. Accordingly, the secondary device receives the HDLC message in step 112 and identifies whether the HDLC message corresponds to an Information Frame (I-Frame) format configured in advance for controlling the operation of the path forming device, in step 114. When the HDLC message corresponds to the I-Frame format, the secondary device proceeds to step 120, and when the HDLC message does not correspond to the I-Frame format, the secondary device proceeds to step 115 to perform other operations, namely, an operation of processing an Unnumbered Frame (U-Frame) used for system management or a Supervisory Frame (S-Frame) used for link control. That is, in an embodiment of the present invention, an instruction for controlling the operation of the path forming device is transmitted by using an I-frame carrying the user information and control information for the user information.

In step 120, the secondary device checks whether the procedure of the currently input frame corresponds to a procedure of the path forming device (SOS) according to an embodiment of the present invention. When the procedure corresponds to the SOS procedure, the process proceeds to step 124, and when the procedure does not correspond to the procedure of the path forming device, the process proceeds to step 122 to process unknown procedures.

In step 124, the secondary device extracts a procedure ID. That is, as shown in FIG. 16B, the Procedure ID value may be ‘0x70’ correspond to the “SOSSetSwitchReset” procedure, ‘0x71’ corresponding to the “SOSGetSwitchStatus” procedure, ‘0x72’ corresponding to the “SOSSetSwitchPort” procedure, or ‘0x73’ corresponding to the “SOSGetSwitchPort” procedure.

Hereinafter, in step 131, the secondary device checks whether the procedure ID value which is checked in step 124 correspond to ‘0x70’. When the procedure ID value corresponds to ‘0x70’, an operation for setting the path of the path forming device to the initial state is performed according to the “SOSSetSwitchReset” procedure, in step 132.

On the other hand, when the procedure ID value which is checked in step 130 does not correspond to ‘0x70’, the process proceeds to step 133 and checks whether the procedure ID value corresponds to ‘0x71’. When the procedure ID value corresponds to ‘0x71’, the process proceeds to step 134 to perform an operation of checking output ends for all input ends of the path forming device according to the “SOSGetSwitchStatus” procedure.

On the other hand, when the procedure ID value which is checked in step 133 does not correspond to ‘0x71’, the process proceeds to step 135 and checks whether the procedure ID value corresponds to ‘0x72’. When the procedure ID value corresponds to ‘0x72’, the process proceeds to step 136 to perform an operation of connecting the input end and output end designated in the primary device according to the “SOSSetSwitchPort” procedure.

On the other hand, when the procedure ID value which is checked in step 135 does not correspond to ‘0x72’, the process proceeds to step 137 and checks whether the procedure ID value corresponds to ‘0x73’. When the procedure ID value corresponds to ‘0x73’, the process proceeds to step 138 to perform an operation of displaying an output end connected to an input end inquiring to the primary device according to the “SOSGetSwitchPort” procedure.

On the other hand, when the procedure ID value which is checked in step 137 does not correspond to ‘0x73’, the process proceeds to step 139 to perform a corresponding operation according to the procedure ID value.

Through the above steps, the secondary device performs a processing operation on the command (frames) received from the primary device, and checks the processing state including the processing result, in step 140. In the subsequent step 150, the secondary device transmits, to the primary device, the HDLC response message notifying of the processing result and whether to perform the normal operation.

As described above, configurations and operations can be made for a wireless high-frequency signal path forming device and a method for controlling the same according to an embodiment of the present invention. On the other hand, the above descriptions of the present invention have been made with reference to detailed embodiments thereof, however various changes can be made without departing from the scope of the invention. For example, in the above description, it has been described with respect to a plurality of procedures, and various procedures may also be set. For example, a procedure may be set for performing an automatic route setting operation, and the operation may be to check the normal operating condition of each amplifier in the path forming device, and when there is an amplifier failure, to perform an operation of automatically changing the path by itself. To this end, the path forming device may perform operations of storing information such as amplitude values and phase values on each path, monitoring the values in real time, and automatically changing the path when trouble occurs.

In addition, in the above description, it has been described that the path forming is made in a direction to maintain the operation of the antenna array located at the center in the whole antenna structure, however, other examples of the present invention may be implemented to achieve the path forming in a direction to maintain the operation of the antenna array located on the edge in the whole antenna structure.

In addition, in the above description, the path forming device was configured to be connected to the plurality of amplifiers, however, a configuration for connecting the path forming device to any other communication device for providing a wireless high-frequency signal may also possible, and a structure of indirectly connecting to the amplifier through the other communication devices can be made.

In the above description, it has been described that a controller (CPU) and the like is provided within the path forming device, the controller may also be separately provided on the outside of the path forming device.

Further, in the above description, it has been described that the remote wireless device, such as the RRH is configured to be attached separately to the outside of the base station antenna, for example, at the front end. In addition, the base station antenna can be implemented such that the remote wireless device is mounted inside the base station antenna.

As described above, a method for forming a wireless high-frequency signal path according to the present invention may enable the base station antenna to maintain the quality of a mobile communication service most stably, and enable the device installed in the base station antenna to be more efficiently controlled.

In addition to that, various modifications and variations can be made without departing from the scope of the present disclosure, and the scope of the present disclosure shall not be determined by the above-described embodiments and has to be determined by the following claims and equivalents thereof.

What is claimed is:

1. A device for forming a wireless high-frequency signal path, comprising:
a plurality of output ends connected so as to correspond to a plurality of antenna arrays, respectively;
a plurality of input ends connected so as to correspond to a plurality of amplifiers, respectively;
a switching module for forming a path for variably connecting each of the plurality of input ends to one output end selected from the plurality of output ends according to a switching control signal; and
a controller for receiving an external command and outputting the switching control signal for controlling a switching operation of the switching module according to the external command.

2. The device as claimed in claim 1, wherein the plurality of output ends comprise at least first to fourth output ends, and the plurality of input ends comprise at least first to fourth input ends; and
the switching module comprises:
1-1st to 1-4th switching points that connect a path between at least the first input end and one of the first to fourth output ends, or disconnect the connected path;
2-1st to 2-4th switching points that connect a path between the second input end and one of the first to fourth output ends, or disconnect the connected path;
3-1st to 3-4th switching points that connect a path between the third input end and one of the first to fourth output ends, or disconnect the connected path; and
4-1st to 4-4th switching points that connect a path between the fourth input end and one of the first to fourth output ends, or disconnect the connected path.

3. The device as claimed in claim 1, wherein the plurality of output ends comprise at least first to fourth output ends, and the plurality of input ends comprise at least first to fourth input ends; and
the switching module comprises:
1-1st to 1-4th switching points that connect a path between the first input end and one of the first to fourth output ends, or disconnects the connected path;
2-2nd to 2-4th switching points that connect a path between the second input end and one of the second to fourth output ends, or disconnect the connected path;
3-3rd to 3-4th switching points that connect a path between the third input end and one of either the third output end or the fourth output end, or disconnect the connected path; and
a 4-4th switching point that connects a path between the fourth input end and the fourth output end, or disconnects the connected path.

4. The device as claimed in claim 1, wherein the path forming device is mechanically installed inside a base station antenna.

5. The device as claimed in claim 1, wherein the path forming device is mechanically installed between the base station antenna and a remote wireless device.

6. A method for controlling a path forming device which is a secondary device for performing a control operation by transmitting/receiving a High-level Data-Link Control (HDLC) message to/from a primary device in accordance with an Antenna Interface Standards Group (AISG) standard, the method comprising:
receiving the HDLC message from the primary device;
extracting a predetermined device address and a procedure ID from the received HDLC message;
checking whether the extracted procedure ID is a procedure ID predetermined with respect to a path configuration between multiple input ends and multiple output ends equipped in the path forming device;
performing an operation of the path configuration between the multiple input ends and the multiple output ends according to the checked procedure ID; and
reporting a result of the performance of the operation to the primary device through a response message.

7. The method as claimed in claim 6, wherein the predetermined procedure comprises:
a procedure for instructing to set the path to an initial state on the path forming device;
a procedure for instructing to notify of a current path configuration state to the path forming device;
a procedure for designating, on the path forming device, an output end to be connected to a particular input end; and
a procedure for instructing to display, on the path forming device, the output end connected to the particular input end.
